(19) United States
(12) Patent Application Publication
(10) Pub. No.: US 2025/0353333 A1
(43) Pub. Date: Nov. 20, 2025

(54) TIRE

(71) Applicant: BRIDGESTONE CORPORATION, Chuo-ku, Tokyo (JP)

(72) Inventor: Hiroyuki KATSUNO, Chuo-ku, Tokyo (JP)

(73) Assignee: BRIDGESTONE CORPORATION, Chuo-ku, Tokyo (JP)

(21) Appl. No.: 18/871,808

(22) PCT Filed: May 26, 2023
(86) PCT No.: PCT/JP2023/019788

§ 371 Date: Dec. 5, 2024

(30) Foreign Application Priority Data
Jul. 7, 2022 (JP) 2022-110070

(51) Int. Cl. B60C 19/00

(52) U.S. Cl. CPC B60C 19/00

(57) ABSTRACT

The provided is a tire 10 comprising a bead filler 5 arranged adjacent to tire radially outer side of the bead core 11, and an electronic device 6 attached to a tire outer surface 10o side than the carcass 4 in the sidewall portion 2, wherein when the nominal rim diameter of the rim for the tire 10 is 20 to 57 inches, the electronic device 6 is arranged at a position where its tire radial distance from an upper end 11a of the bead core 11 is 105 to 200% of a tire radial height of the bead filler 5, and when the same is larger than 57 inches, the electronic device 6 is arranged at a position where its tire radial distance from an upper end 11a of the bead core 11 is 105 to 330% of a tire radial height of the bead filler 5.

### TECHNICAL FIELD

This application claims priority to Patent Application No. 2022-110070, filed in Japan on Jul. 7, 2022, the entire contents of which are incorporated herein by reference.

### BACKGROUND

A configuration in which an electronic device such as an RF tag is attached to a tire has been known. For example, PTL 1 discloses a tire with an electronic device attached to the sidewall.

### CITATION LIST

### Patent Literature

PTL 1: JP 2021-008266 A

### SUMMARY

### Technical Problem

However, in particular, when the tire size and thus the load applied to the tire are large, the effect of the bending strain which is caused by the large deflection in the tire width direction near the tire maximum width position in the sidewall portion of the tire is large, and it was found that there is room for improvement in the durability of the electronic device attached to the sidewall portion.

Therefore, an object of the present disclosure is to provide a tire that can improve the durability of an electronic device attached to the outer surface side of the sidewall portion of a large-sized tire.

### Solution to Problem

The above problem can be solved by the following means.

(1) The tire of this disclosure is a tire,
comprising a pair of bead portions having a bead core, a carcass consisting of at least one carcass ply that extends between the pair of bead portions via a pair of sidewall portions and a tread portion, a bead filler arranged adjacent to an outer side in the tire radial direction of the bead core, and an electronic device attached to a tire outer surface side than the carcass in the sidewall portion, wherein
a nominal rim diameter of an applicable rim for the tire is 20 inches or more,
when the nominal rim diameter of the applicable rim for the tire is 20 to 57 inches, the electronic device is arranged at a position where its tire radial distance from an upper end of the bead core is 105 to 200% of a tire radial height of the bead filler from the upper end of the bead core, and
when the nominal rim diameter of the applicable rim for the tire is larger than 57 inches, the electronic device is arranged at a position where its tire radial distance from an upper end of the bead core is 105 to 330% of a tire radial height of the bead filler from the upper end of the bead core.

### Advantageous Effect

According to the present disclosure, it is possible to provide a tire that can improve the durability of an electronic device attached to the outer surface side of the sidewall portion of a large-sized tire.

### BRIEF DESCRIPTION OF THE DRAWINGS

In the accompanying drawings:

FIG. 1 is a schematic cross-sectional view in the tire width direction of a tire according to one embodiment of the present disclosure;

FIG. 2 is a plan view schematically illustrating an example of an electronic device that can be used in a tire according to one embodiment of the present disclosure;

FIG. 3 is a schematic partial cross-sectional view in the tire width direction to explain the arrangement position of an electronic device in an example according to one embodiment of the present disclosure; and

FIG. 4 is a schematic partial cross-sectional view in the tire width direction to explain the arrangement position of an electronic device in another example according to one embodiment of the present disclosure.

### DETAILED DESCRIPTION

The tire according to this disclosure can be used well as, for example, an OR tire (tire for construction and mining vehicles).

Hereinafter, embodiments of a tire according to the present disclosure will be described with reference to the drawings.

The same components and parts are designated by the same reference numerals/symbols in each drawing.

As used herein, the term “tire circumferential direction” refers to the direction in which the tire rotates around its rotation axis (axis line), the term “tire radial direction” refers to the direction that is perpendicular to the rotation axis of the tire, and the term “tire width direction” refers to the direction that is parallel to the rotation axis of the tire. In some drawings, the tire circumferential direction is indicated by the symbol “CD”, the tire radial direction is indicated by the symbol “RD”, and the tire width direction is indicated by the symbol “WD”

In addition, as used herein, the side that is closer to the rotation axis of the tire along the tire radial direction is referred to as the “inner side in the tire radial direction”, and the side that is farther from the rotation axis of the tire along the tire radial direction is referred to as the “outer side in the tire radial direction”.

In addition, as used herein, the side that is closer to the tire equatorial plane CL along the tire width direction is referred to as the “inner side in the tire width direction”, and the side that is further from the tire equatorial plane CL along the tire width direction is referred to as the “outer side in the tire width direction”.

Further, as used herein, the phrase “extending in the tire circumferential direction” means extending with at least a tire circumferential component. That is, the phrase “extending in the tire circumferential direction” means that it may extend in a direction that follows the tire circumferential direction (i.e. at an angle of 0° to the tire circumferential direction, without inclining with respect to the tire circumferential direction), or it may extend at an angle other than 90° to the tire circumferential direction (i.e. at an inclination angle of more than 0° and less than 90° with respect to the tire circumferential direction).

Furthermore, as used herein, the phrase “extending in the tire width direction” means extending with at least a tire widthwise component. That is, the phrase “extending in the tire width direction” means that it may extend in a direction that follows the tire width direction (i.e. at an angle of 0° to the tire width direction, without inclining with respect to the tire width direction), or it may extend at an angle other than 90° to the tire width direction (i.e. at an inclination angle of more than 0° and less than 90° with respect to the tire width direction).

Unless otherwise specified, the position and dimensions of each element shall be measured under the reference conditions where the tire is mounted on the applicable rim, filled with the prescribed internal pressure, and unloaded. In addition, the term “tread surface” refers to the outer surface around the entire circumference of the tire that is in contact with the road surface when the tire is mounted on the applicable rim, filled with the prescribed internal pressure, and rolled under a maximum load, and the edges in the tire width direction of the tread surface are referred to as the “tread edges”.

As used herein, the term “applicable rim” refers to the standard rim in the applicable size (Measuring Rim in ETRTO's STANDARDS MANUAL and Design Rim in TRA's YEAR BOOK) as described or as may be described in the future in the industrial standard, which is valid for the area in which the tire is produced and used, such as JATMA YEAR BOOK of JATMA (Japan Automobile Tyre Manufacturers Association) in Japan, STANDARDS MANUAL of ETRTO (The European Tyre and Rim Technical Organization) in Europe, and YEAR BOOK of TRA (The Tire and Rim Association, Inc.) in the United States. For sizes not listed in these industrial standards, the term “applicable rim” refers to a rim with a width corresponding to the bead width of the pneumatic tire. The “applicable rim” includes current sizes as well as future sizes to be listed in the aforementioned industrial standards. An example of the “sizes as described in the future” could be the sizes listed as “FUTURE DEVELOPMENTS” in the ETRTO 2013 edition.

As used herein, the term “prescribed internal pressure” refers to the air pressure (maximum air pressure) corresponding to the maximum load capacity of a single wheel in the applicable size and ply rating, as described in the aforementioned JATMA YEAR BOOK and other industrial standards. In the case that the size is not listed in the aforementioned industrial standards, the term “prescribed internal pressure” refers to the air pressure (maximum air pressure) corresponding to the maximum load capacity specified for each vehicle in which the tire is mounted. Further, as used herein, the term “maximum load” means the load corresponding to the maximum load capacity in the tire of the applicable size described in the aforementioned industrial standards, or, for sizes not listed in the aforementioned industrial standards, the load corresponding to the maximum load capacity specified for each vehicle in which the tire is mounted.

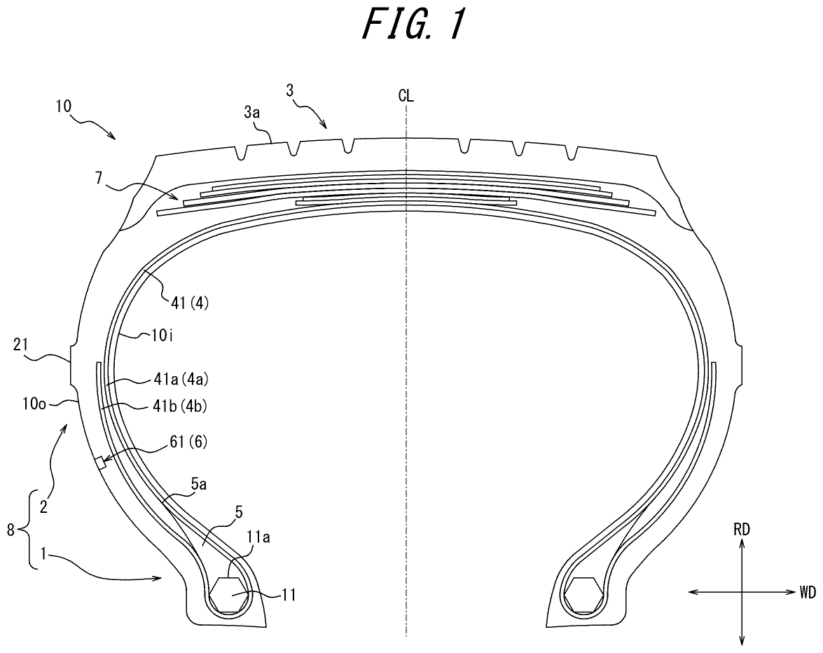

FIG. 1 is a drawing to explain a tire 10 according to one embodiment of the present disclosure, and is a schematic cross-sectional view in the tire width direction of the tire 10.

It will be noted that the tire 10 according to the embodiment of this disclosure may be configured as any type of tire as long as the nominal rim diameter of the applicable rim is 20 inches or more.

As used herein, the term “nominal rim diameter of applicable rim” (hereinafter, simply referred to as “nominal rim diameter”) refers to the inner diameter of the tire, and thus the rim diameter of the applicable rim mentioned above. More specifically, the term refers to the designation (in inches) of the rim diameter of the applicable rim, which is generally indicated in the tire size displayed on the sidewall portion of the tire, in other words, to the rim diameter of the applicable rim expressed in inches. For example, if the tire size is “29.5R25”, the nominal rim diameter is “25 inches”, if the tire size is “18.00R33”, the nominal rim diameter is “33 inches”, if the tire size is “46/90R57”, the nominal rim diameter is “57 inches”, and if the tire size is “59/80R63”, the nominal rim diameter is “63 inches”.

As illustrated in FIG. 1, the tire 10 according to this embodiment has a bead portion 1, a sidewall portion 2, and a tread portion 3. The bead portion 1 is a portion that is configured to come into contact with a rim on its inner side in the tire radial direction and on its outer side in the tire width direction when the tire 10 is mounted on a rim. The tread portion 3 is a portion of the tire 10 that extends in the tire width direction between a pair of tread edges. The sidewall portion 2 is a portion that extends between the pair of bead portions 1 and the tread portion 3. In this document, the sidewall portion 2 and the bead portion 1 are sometimes collectively referred to as a tire side portion 8. The above-mentioned sidewall portion 2 refers to the portion that extends to the inner side in the tire radial direction than at least a belt 7 mentioned below and to the outer side in the tire radial direction from the bead portion 1.

More specifically, the tire 10 of this embodiment comprises: a pair of bead portions 1 having a bead core 11, a carcass 4 consisting of at least one carcass ply 41 that extends between the pair of bead portions 1 via the pair of sidewall portions and the tread portion, a bead filler 5 arranged adjacent to the outer side in the tire radial direction of the bead core 11, and an electronic device 6 attached to the tire outer surface 10o side than the carcass 4 in the sidewall portion 2.

In this embodiment, the tire 10 has the pair of bead portions 1. Each of the pair of bead portions 1 has a bead core 11. Each of the bead cores 11 is embedded in the corresponding bead portion 1. The bead core 11 may include a plurality of bead wires that are surrounded by a rubber coating. However, the bead core 11 may consist of a single bead wire. The bead wire is preferably made of metal (e.g. steel). For example, the bead wire may be, for example, formed of monofilament or stranded wire. In addition, the bead wire may be made of organic fibers or carbon fibers, etc.

In this example, as illustrated in FIG. 1, the cross-sectional shape of the bead core 11 in the tire width direction is a regular hexagon, however, the cross-sectional shape of the bead core 11 may be another shape, such as a polygonal shape other than a regular hexagon or a circular shape.

In this embodiment, the tire 10 has the carcass 4 consisting of at least one carcass ply 41. The at least one carcass ply 41, and thus the carcass 4 extends between the pair of bead portions 1 via the pair of sidewall portions 2 and the tread portion 3. More specifically, the carcass ply 41, and thus the carcass 4 extends in a toroidal shape from one bead portion 1 to the other bead portion 1 via one sidewall portion 2, the tread portion 3, and the other sidewall portion 2.

In the present example, as illustrated in FIG. 1, the carcass ply 41 (and thus, the carcass 4) comprises a ply body portion 41a (and thus, a carcass body portion 4a) located between the bead cores 11 of the pair of bead portions 1, and ply turn-up portions 41b (and thus, carcass turn-up portions 4b) folded from the inner side to the outer side in the tire width direction around each bead core 11 from both ends of the ply body portion 41a (carcass body portion 4a). However, the carcass ply 41 (carcass 4) does not have to comprise the ply turn-up portions 41b (carcass turn-up portions 4b).

In this example, as illustrated in FIG. 1, the carcass 4 is composed of a single carcass ply 41. However, the carcass 4 may be composed of a plurality of carcass plies 41.

Each carcass ply 41 contains one or more carcass cords and a coating rubber that covers the carcass cords. The carcass cord may be formed of monofilament or stranded wire, for example.

In this embodiment, the carcass cord of the carcass ply 41 is made of steel. To be more specific, each of the plurality of carcass cords contained in each carcass ply 41 is made of steel. Because the carcass cords are made of steel, sufficient strength can be obtained even in large tires with a simple radial carcass structure.

In addition, in this embodiment, the carcass 4 has a radial structure. In other words, each carcass cord included in the carcass 4 extends substantially along the tire width direction (i.e., in a projection view from the outer side in the tire radial direction of the tread portion 3, at an angle of substantially 0°, without inclining, with respect to the tire width direction).

However, the carcass cord may be made from organic fibers such as polyester, nylon, rayon, and aramid. In addition, the carcass 4 may be a bias structure.

In this embodiment, the tire 10 has the bead filler 5. As illustrated in FIG. 1, the bead filler 5 is arranged adjacent to the outer side in the tire radial direction of the bead core 11. In other words, as illustrated in FIGS. 1, 3 and 4, the bead filler 5 is in contact with the outer portion in the tire radial direction of each corresponding bead core 11, and extends from the upper end 11a of the each bead core 11 toward the outer side in the tire radial direction to the upper end 5a of the bead filler 5. In each of the examples in FIGS. 1, 3 and 4, the bead filler 5 extends in a tapering shape toward the outer side in the tire radial direction. The bead filler 5 is made of hard rubber, for example.

It will be noted that, as in the example in FIG. 1, there may be cases where a plurality of (for example, two) rubber members of different materials with different hardness are arranged in layers along the tire radial direction, for example, on the outer side in the tire radial direction of the bead core 11 (in particular, between the carcass body portion 4a and the carcass turn-up portion 4b, for example, on the outer side in the tire radial direction of the bead core 11). However, in this document, the term “bead filler” refers to a single rubber member that is arranged adjacent to (i.e., in contact with) the outer side in the tire radial direction of the bead core 11.

In this embodiment, the tire 10 has the electronic device 6.

As used herein, the term “electronic device” refers to a device that comprises electronic components and has communication functions with the outside world, for example.

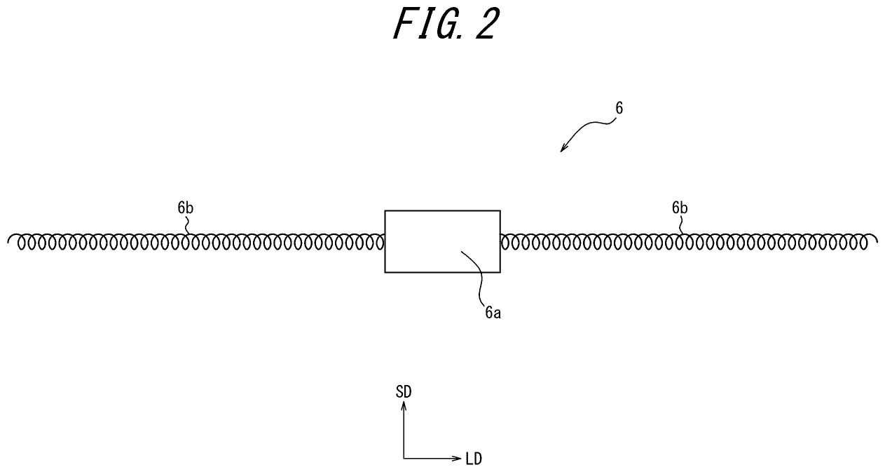

FIG. 2 is a plan view schematically illustrating an example of an electronic device that can be used in a tire according to one embodiment of the present disclosure.

In the example in FIG. 2, the electronic device 6 is an RF tag that has an IC chip 6a with a storage section, etc., and one or more (in the illustrated example, two) antennas 6b that transmit and/or receive electromagnetic waves. The RF tag is also commonly referred to as an RFID (Radio Frequency Identification) tag.

In this example, the antennas 6b are connected to the IC chip 6a and extends in a straight line, a wave-like shape, or a spiral shape (in the illustrated example, a spiral shape). In this example, two antennas 6b extend from the IC chip 6a in opposite directions. However, the antennas 6b may extend from the IC chip 6a in only one direction. In addition, in this example, the two antennas 6b have the same length along the long side direction LD of the IC chip 6a, which will be described later. However, the two antennas may have different lengths along the long side direction LD of the IC chip 6a.

In this example, the IC chip 6a has a thin plate shape with a generally rectangular shape in a plan view. Here, the “thickness” of the IC chip 6a refers to the thickness in the direction perpendicular to both of: the direction, in a plan view, parallel to the long side of the IC chip 6a (hereafter, also referred to as the “long side direction of the IC chip (6a)”) LD; and the direction, in a plan view, parallel to the short side of the IC chip 6a (hereafter, also referred to as the “short side direction of IC chip (6a)”) SD. The IC chip 6a has, for example, a storage section that is any known memory and a controller that is any known processor. The IC chip 6a may operate by the induced electromotive force generated by the electromagnetic waves received by the one or more antennas 6b. In other words, the electronic device 6 may be a passive communication device. Alternatively, the electronic device 6 may be further provided with a battery and be able to generate electromagnetic waves and communicate using its own power. In other words, the electronic device 6 may be an active communication device. The controller of the IC chip 6a can, for example, read data such as production management, shipping management, and usage history management of the tire stored in the storage section, or write these data to the storage section.

In this embodiment, as illustrated in FIG. 1, the electronic device 6 (e.g., an RF tag) is attached to the tire outer surface 10o side than the carcass 4 in the sidewall portion 2. Here, in this document, the term “tire outer surface” refers to the surface of the tire that faces the outside of the tire, not the inner cavity of the tire. In addition, in case that the carcass 4 has the carcass body portion 4a and the carcass turn-up portion 4b, the term “tire outer surface 10o side than the carcass 4 in the sidewall portion 2” refers to, as illustrated in the example in FIG. 1 for example, the side closer to the tire outer surface 10o than both the carcass body portion 4a and the carcass turn-up portion 4b. The electronic device 6 may be embedded in the sidewall portion 2 or attached to the tire outer surface 10o on the sidewall portion 2, as long as it is attached to the tire outer surface 10o side than the carcass 4 in the sidewall portion 2. In the example in FIG. 1, the electronic device 6 is embedded in the sidewall portion 2.

The electronic device 6 may be attached, on the tire outer surface 10o side, in the state of the electronic device 6 itself, which comprises the IC chip 6a and the antennas 6b as illustrated in FIG. 2, for example. Alternately, the electronic device 6 may be attached, on the tire outer surface 10o side, as an electronic device laminate 61 in which the IC chip 6a of the electronic device 6 is covered on both sides in the thickness direction with thin sheet-like coating rubber. Alternately, the electronic device 6 may be attached, on the tire outer surface 10o side, as an electronic device laminate 61 in which one side (the bottom side) of the IC chip 6a of the electronic device 6 is covered with thin sheet-like coating rubber and the other side (the top side) is covered with slightly thicker patch rubber. The electronic device 6 or the electronic device laminate 61, which contains electronic device 6, may be attached to the tire outer surface 10o of the vulcanized tire 10, for example, using an adhesive cement, or may be embedded in a recess provided on the tire outer surface 10o of the vulcanized tire 10 with an adhesive, etc., or may be attached to the tire 10 (raw tire) before vulcanization and embedded in the tire outer surface 10o side of the tire 10 by vulcanization adhesion at the same time as the vulcanization of the tire 10.

It will be noted that, in FIG. 1, the electronic device laminate 61, which contains the electronic device 6, is illustrated in a simplified form, however in this embodiment, the electronic device 6 is attached to the tire outer surface 10o side so that the top and bottom surfaces (front and back surfaces) of the thin IC chip 6a are along with the tire outer surface 10o (i.e., in a way that the two surfaces are almost parallel).

In the example illustrated in FIG. 1, the tire 10 further comprises the belt 7 consisting of at least one layer (in the illustrated example, six layers) of belt layers in the tread portion 3. The belt 7 is arranged on the outer side in the tire radial direction of the crown portion of the carcass 4. Each belt layer contains one or more belt cords and a coating rubber that covers the belt cords. The belt cord can be formed of monofilament or stranded wire, for example. The belt cord may be made of metal (e.g. steel) or organic fibers such as polyester, nylon, rayon, or aramid.

In addition, in the illustrated example, tread rubber that forms a tread surface 3a is provided on the outer side in the tire radial direction of the belt 7 in the tread portion 3. A tread pattern is formed on the tread surface 3a. The tread pattern is not particularly limited.

Furthermore, in the illustrated example, side rubber that forms an outer surface 10o of the tire side portion 8 is provided on the outer side in the tire width direction of the carcass 4 in the tire side portion 8. In addition, in the illustrated example, a protrusion 21, which is generally referred to as a “decoline”, protruding flatly toward the outside of the tire 10 and extending in a ring shape in the tire circumferential direction at a tire radial position including the tire maximum width position of the tire 10, is formed in the sidewall portion 2 in order to improve the appearance of the tire 10, improve cut resistance, and protect the carcass 4, etc.

In addition, the inner surface 10i of the tire 10 in this embodiment is composed of an inner liner (not illustrated in particular) with low permeability to air and/or gas.

In this embodiment, the nominal rim diameter of an applicable rim for the tire 10 is 20 inches or more. In other words, the tire 10 in this embodiment is a large-sized, large-scale tire.

It will be noted that when the nominal rim diameter for the tire 10 is 20 inches or more, from the perspective of ensuring sufficient strength in the vicinity of the bead portion 1, it is preferable that the maximum width of the area in which the bead filler 5 exists (hereinafter, also referred to as the “bead filler area”) excluding the electronic device 6 (hereinafter, also referred to as the “maximum width of the bead filler area”) is preferably 30 mm or more. Here, in this document, the above-mentioned “bead filler area” more specifically refers to the area extending from the tire inner surface 10i to the tire outer surface 10o, where the bead filler 5 is present, when viewed in the direction perpendicular to the tire inner surface 10i in the cross-sectional view in the tire width direction. In addition, the “maximum width of the bead filler area” mentioned above shall refer to the maximum width when the width of the bead filler area is measured in the direction perpendicular to the tire inner surface 10i in the cross-sectional view in the tire width direction.

The following explains the more specific arrangement position, etc. of the electronic device 6 attached to the tire outer surface 10o side in this embodiment.

Even among the large-sized tires with a nominal rim diameter of 20 inches or more, the internal dimensions of the tire, especially the bead filler height BH, etc., described below, differ greatly depending on the size of the tire. Therefore, in the following, the size (nominal rim diameter) will be explained separately for two sizes.

### <When the Nominal Rim Diameter is 20 to 57 Inches>

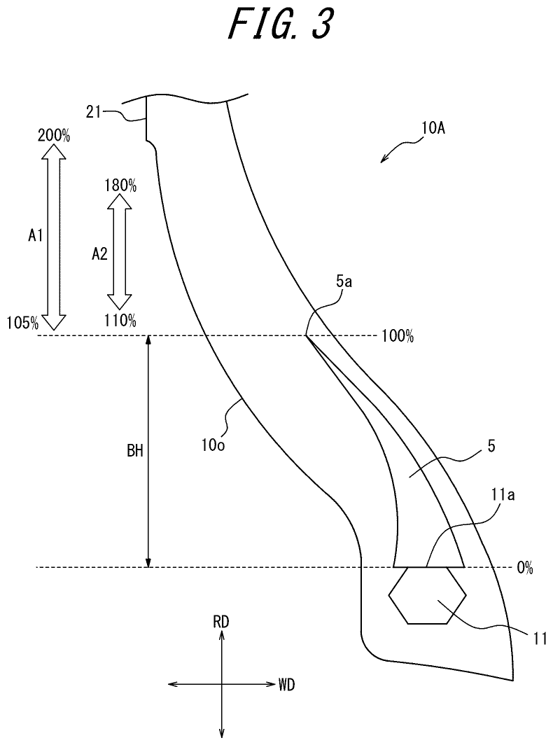

FIG. 3 is a schematic partial cross-sectional view in the tire width direction to explain the arrangement position of the electronic device 6 (see FIG. 1) in the tire 10A in one example according to one embodiment of the present disclosure. More specifically, FIG. 3 is a schematic cross-sectional view of the tire 10A, with a nominal rim diameter of 20 to 57 inches or more (also referred to as a “first-size tire”), from the sidewall portion to the bead portion. For the purposes of explanation, the shape of the bead filler 5 is simplified, and the carcass 4 (see FIG. 1) is not illustrated. The configuration of the first-size tire 10A other than its size (nominal rim diameter) is basically the same as the tire 10 described above. In other words, the first-size tire 10A is one type of the tire 10 described above. Therefore, in the following description, the reference numerals and symbols used in FIGS. 1 to 2 will also be used where appropriate.

In the case of the first-size tire 10A, that is, when the nominal rim diameter for the tire 10 is 20 to 57 inches, the maximum width of the bead filler area is preferably 30 mm or more from the perspective of ensuring sufficient strength in the vicinity of the bead portion 1, and 80 mm or less from the perspective of avoiding increases in tire weight, etc.

Examples of nominal rim diameters of applicable rims for the first-size tire 10A include 25 inches, 29 inches, 33 inches, 35 inches, 49 inches, 51 inches, and 57 inches, etc.

In this embodiment, if the tire 10 is the first-size tire 10A (that is, if the nominal rim diameter of the applicable rim for the tire 10 is 20 to 57 inches), the electronic device 6 (see FIG. 1) is arranged at the position where its tire radial distance from an upper end 11a of the bead core 11 is 105 to 200% of a tire radial height BH of the bead filler 5 (Hereafter, also referred to simply as “bead filler height”.) from the upper end 11a of the bead core 11 (in other words, within the tire radial region A1 illustrated in FIG. 3). Here, the “position where its tire radial distance from an upper end 11a of the bead core 11 is 105 to 200% of a tire radial height BH of the bead filler 5 from the upper end 11a of the bead core 11” refers, more specifically, to the tire radial position between: the tire radial position where its tire radial distance from the upper end 11a of the bead core 11 is 105% of the bead filler height BH, and the tire radial position that is on the outer side in the tire radial direction than the above tire radial position, and where its tire radial distance from the upper end 11a of the bead core 11 is 200% of the bead filler height BH.

It will be noted that, in this document, when it is said that the electronic device 6 is “arranged in a certain position”, unless otherwise specified, it means that at least the center of the longitudinal direction of the electronic device 6, including the antenna 6b, is arranged in that position.

<When the Nominal Rim Diameter is Larger than 57 Inches>

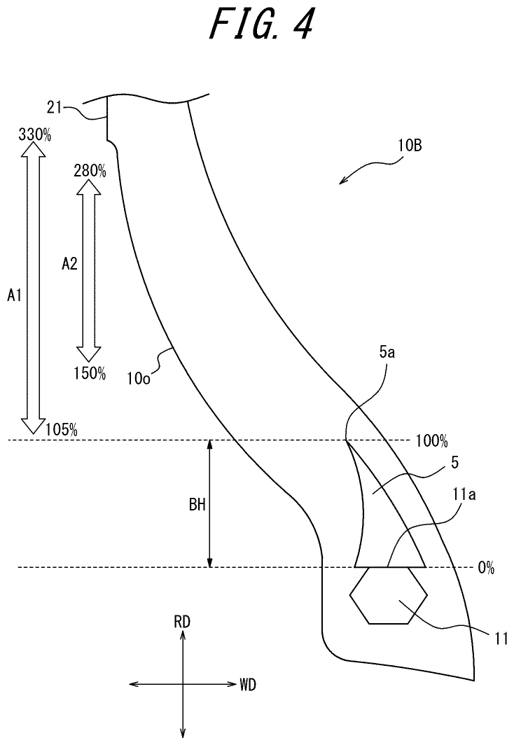

FIG. 4 is a schematic partial cross-sectional view in the tire width direction to explain the arrangement position of the electronic device 6 (See FIG. 1) on the tire 10B in another example according to one embodiment of the present disclosure. More specifically, FIG. 4 is a schematic cross-sectional view of the tire 10B, with a nominal rim diameter of larger than 57 inches (also referred to as a “second-size tire”), from the sidewall portion to the bead portion. For the purposes of explanation, the shape of the bead filler 5 is simplified, and the carcass 4 (see FIG. 1) is not illustrated. As with the first-size tire 10A mentioned above, the configuration of the second-size tire 10B other than its size (nominal rim diameter) is also basically the same as the tire 10 described above. In other words, the second-size tire 10B is one type of the tire 10 described above. Therefore, in the following description, the reference numerals and symbols used in FIGS. 1 to 2 will also be used where appropriate.

In the case of the second-size tire 10B, that is, when the nominal rim diameter for the tire 10 is larger than 57 inches, the maximum width of the bead filler area is preferably larger than 80 mm from the perspective of ensuring sufficient strength in the vicinity of the bead portion 1, and 140 mm or less from the perspective of avoiding increases in tire weight, etc.

Examples of nominal rim diameters of applicable rims for the second-size tire 10B include 63 inches, etc.

In this embodiment, if the tire 10 is the second-size tire 10B (that is, if the nominal rim diameter of the applicable rim for the tire 10 is larger than 57 inches), the electronic device 6 (see FIG. 1) is arranged at the position where its distance in the tire radial direction from an upper end 11a of the bead core 11 is 105 to 330% of the tire radial height BH of the bead filler 5 from the upper end 11a of the bead core 11 (in other words, within the tire radial region A1 illustrated in FIG. 4).

Next, the effects of the above-mentioned embodiment will be described.

First, in this embodiment, an electronic device 6 is attached to the tire outer surface 10o side than the carcass 4 in the sidewall portion 2. This ensures that the electronic device 6 has sufficient communication performance with the outside of the tire 10, compared to when the electronic device 6 is attached to the tire inner surface 10i side than the carcass 4 in the sidewall portion 2, for example, on the tire inner surface 10i.

Next, in this embodiment, the nominal rim diameter of the applicable rim for the tire 10 is 20 inches or more, and when the nominal rim diameter of the applicable rim for the tire 10 is 20 to 57 inches (in other words, when the tire 10 is the first-size tire 10A), the electronic device 6 is arranged at a position where its tire radial distance from the upper end 11a of the bead core 11 is 105 to 200% of the tire radial height BH of the bead filler 5 from the upper end 11a of the bead core 11. This improves the durability of the electronic device 6 in the first-size tire 10A. That is, it was found that when the electronic device 6 is arranged on the tire outer surface 10o side than the carcass 4 of the sidewall portion 2, which is the neutral axis of bending, there was a high risk of failure or detachment of the electronic device 6 due to the tensile stress caused by the bending strain in the cross-sectional view in the tire width direction. Therefore, the values of the bending strain at each position in the tire radial direction for the first-size tire 10A were calculated using FEM simulations. As a result, it was found that the value of the bending strain becomes sufficiently low (e.g. 10% or less) at the position where its tire radial distance mentioned above is 105% to 200% of the bead filler height BH. When the above tire radial distance is less than 105% of the bead filler height BH, or greater than 200% of the same, the electronic device 6 will not have sufficient durability.

From the same perspective, it is preferable that the nominal rim diameter of the applicable rim for the tire 10 is 20 to 57 inches (in other words, the tire 10 is the first-size tire 10A), and the electronic device 6 is arranged at a position where its tire radial distance from the upper end 11a of the bead core 11 is 110 to 180% of the tire radial height BH of the bead filler 5 from the upper end 11a of the bead core 11. In this case, the durability of the electronic device 6 can be further improved in the first-size tire 10A.

In addition, in this embodiment, the nominal rim diameter of the applicable rim for the tire 10 is 20 inches or more (in other words, when the tire 10 is the second-size tire 10B), and when the nominal rim diameter of the applicable rim for the tire 10 is larger than 57 inches, the electronic device 6 is arranged at a position where its tire radial distance from the upper end 11a of the bead core 11 is 105 to 330% of the tire radial height BH of the bead filler 5 from the upper end 11a of the bead core 11. This improves the durability of the electronic device 6 in the second-size tire 10B. That is, in the same way as the previously mentioned first-size tire 10A, the values of the bending strain at each position in the tire radial direction for the second-size tire 10B were calculated using FEM simulations. As a result, it was found that the value of the bending strain becomes sufficiently low (e.g. 10% or less) at the position where its tire radial distance mentioned above is 105% to 330% of the bead filler height BH. When the above tire radial distance is less than 105% of the bead filler height BH, or greater than 330% of the same, the electronic device 6 will not have sufficient durability.

From the same perspective, it is preferable that the nominal rim diameter of the applicable rim for the tire 10 is larger than 57 inches (in other words, the tire 10 is the second-size tire 10B), and the electronic device 6 is arranged at a position where its tire radial distance from the upper end 11a of the bead core 11 is 150 to 280% of the tire radial height BH of the bead filler 5 from the upper end 11a of the bead core 11. In this case, the durability of the electronic device 6 can be further improved in the second-size tire 10B.

From the above, according to the tire 10 of the present embodiment, it is possible to provide a tire that can improve the durability of an electronic device 6 attached to the tire outer surface 10o side of the sidewall portion 2 of the large-sized tire 10.

The following explains the suitable configurations and examples of modifications, etc., of the tire 10 in this embodiment in more detail.

In this embodiment, it is preferable that the electronic device 6 is arranged at a position where its depth from the outer surface of the sidewall portion 2 is 0.5 to 5.0 mm. In this case, the electronic device 6 is less likely to be damaged while traveling of the vehicles, and this in turn improves the durability of the electronic device 6.

It will be noted that if the electronic device 6 is an RF tag such as the one illustrated in FIG. 2, the top and bottom surfaces (front and back surfaces) of the thin plate-shaped IC chip 6a may be attached to the above-mentioned tire outer surface 10o side so that they are aligned with (i.e., so that they are approximately parallel to) the outer surface 10o, and the center in the thickness direction of the IC chip 6a may be arranged at the above-mentioned depth position.

In this embodiment, it is preferable that the electronic device 6 is arranged at the tire circumferential position that overlaps with a position of the tire serial display when viewed in the tire axial direction. In particular, when the tire is large, it is difficult for the operator to grasp the tire circumferential position where the electronic device 6 is attached in a short time, so it is preferable to display the position in advance by some means. According to the above configuration, by using the serial display indicating the production number, etc. of the tire, which is usually indicated by an imprint, etc. on the tire side portion 8, it is possible to easily determine the location of the electronic device 6, using a simple configuration and without using any other new special means.

It will be noted that the phrase “the electronic device 6 is arranged at the tire circumferential position that overlaps with a position of a tire serial display when viewed in the tire axial direction” means that it is sufficient if at least part of the electronic device 6 overlaps with the above position, and it also means that the electronic device 6 may be arranged in a position where at least part of the electronic device 6 only overlaps in the tire circumferential direction with the position of the tire serial display without overlapping with the position of the same in the tire radial direction. However, it is preferable that at least part of the electronic device 6 is arranged in a position that overlaps with the above-mentioned position both in the tire circumferential direction and in the tire radial direction. In addition, in the above case, the electronic device 6 can be installed by embedding it at the tire circumferential position that overlaps with the position of the tire serial display.

In this embodiment, when the electronic device 6 is an RF tag such as the one illustrated in FIG. 2, and has an antenna 6b, the electronic device 6 may be attached to the tire 10 so that the antenna 6b extends in the direction intersecting the extending direction (preferably, in a direction perpendicular to the extending direction) of the carcass cord included in the carcass ply 41 when viewed in the tire axial direction. If the carcass 4 has a radial structure, in this case, the electronic device 6 is prevented from being bent significantly by the bending strain of the sidewall portion 2 over the entire length of the electronic device 6, and the durability of the electronic device 6 can be improved.

From the perspective of resistance to external damage, in this embodiment, the electronic device 6 is preferably arranged on the inner side in the tire radial direction than the tire maximum width position (more specifically, than the tire radial position that is the innermost position in the tire radial direction among the tire maximum width positions in the tire radial direction (much more specifically, for example, in FIGS. 3 and 4, than the tire radial position of the inner edge in the tire radial direction of the plane of the flat-shaped protrusion 21)).

In this embodiment, a plurality of electronic devices 6 with the same arrangement and configuration as the electronic devices 6 in the above examples may be attached to the tire outer surface 10o side at different positions around the circumference of the tire. In addition, in this embodiment, a plurality of electronic devices may be attached to the tire outer surface 10o side at different positions around the circumference of the tire, for example, with at least one electronic device having the same arrangement and configuration as the electronic device 6 in each of the above examples, and at least one electronic device having a different arrangement or configuration than the electronic device 6 in each of the above examples.

In these cases, one or more of the electronic devices are arranged in one half of the tire in the tire width direction, with the tire equatorial plane CL as the boundary, and one or more of the electronic devices are arranged in the other half of the tire in the tire width direction, with the tire equatorial plane CL as the boundary. It is preferable that the plurality of electronic devices are arranged so that, when viewed in the tire axial direction, they are separated from each other by at least 45° in the tire circumferential direction, with the center of the rotation axis (axis line) of the tire as the center. In this case, even if a failure or detachment occurs in at least one of the plurality of electronic devices, there is a high possibility that one of the other electronic devices will remain functional, and thus, it can prevent electronic devices from being unable to read or write information on the tire 10, for example.

In the above case, it is preferable that the plurality of electronic devices are arranged at equal intervals in the tire circumferential direction. This arrangement makes it possible to even out the impact of events that can cause a failure or detachment of the electronic devices while traveling of the vehicles, and to ensure that one of the electronic devices will remain functional. In the context of the phrase “arranged at equal intervals in the tire circumferential direction”, the electronic devices may be arranged at equal intervals in either or both of the respective halves of the tire in the tire width direction without considering which half of the tire the electronic devices are located in; or the electronic devices may be arranged at equal intervals when viewed in the tire axial direction, with both of the halves of the tire in the tire width direction combined.

In addition, in the above case, it is preferable that the electronic devices arranged in one half of the tire in the tire width direction and the electronic devices arranged in the other half of the tire in the tire width direction are arranged alternately in the tire circumferential direction. According to this arrangement, if an event that causes a failure occurs in one electronic device, the other electronic device, which is adjacent to the one electronic device in the tire circumferential direction, is located in a different half of the tire in the tire width direction to the half of the tire where the one electronic device located in, so that to avoid as much as possible the effects of events that could cause a failure in the other electronic device.

Furthermore, in the above case, it is preferable that the number of electronic devices arranged in one half of the tire in the tire width direction is the same as the number of electronic devices arranged in the other half of the tire in the tire width direction. In this case, the impact of the event causing the failure can be further even out.

The above description is an example of an exemplary embodiment of the present disclosure, and various changes can be made without departing from the scope of the claims.

For example, in addition to the electronic device 6 of the above-mentioned arrangement and configuration attached to the tire outer surface 10o side of the tire 10, as described above, at least one electronic device of the same or different configuration as the electronic device 6 may be attached to a location other than the tire outer surface 10o side of the tire.

### INDUSTRIAL APPLICABILITY

The tire according to this disclosure can be used well as, for example, an OR tire (tire for construction and mining vehicles).

### REFERENCE SIGNS LIST

1 Bead portion
11 Bead core
11a Upper end of bead core
2 Sidewall portion
21 Protrusion
3 Tread portion
3a Tread surface
4 Carcass
4a Carcass body portion
4b Carcass turn-up portion
41 Carcass ply
41a Ply body portion
41b Ply turn-up portion
5 Bead filler
5a Upper end of bead filler
6 Electronic device
6a IC chip
6b Antenna
61 Electronic device laminate
7 Belt
8 Tire side portion
10 Tire
10A Tire (first-size tire)
10B Tire (second-size tire)
10i Tire inner surface
10o Tire outer surface
A1, A2 Tire radial region
BH Bead filler height
CD Tire circumferential direction
CL Tire equatorial plane
LD Long side direction
RD Tire radial direction
SD Short side direction

1. A tire comprising a pair of bead portions having a bead core, a carcass consisting of at least one carcass ply that extends between the pair of bead portions via a pair of sidewall portions and a tread portion, a bead filler arranged adjacent to an outer side in the tire radial direction of the bead core, and an electronic device attached to a tire outer surface side than the carcass in the sidewall portion, wherein
a nominal rim diameter of an applicable rim for the tire is 20 inches or more,
when the nominal rim diameter of the applicable rim for the tire is 20 to 57 inches, the electronic device is arranged at a position where its tire radial distance from an upper end of the bead core is 105 to 200% of a tire radial height of the bead filler from the upper end of the bead core, and
when the nominal rim diameter of the applicable rim for the tire is larger than 57 inches, the electronic device is arranged at a position where its tire radial distance from an upper end of the bead core is 105 to 330% of a tire radial height of the bead filler from the upper end of the bead core.

2. The tire according to claim 1, wherein a nominal rim diameter of an applicable rim for the tire is 20 to 57 inches, and
the electronic device is arranged at a position where its tire radial distance from an upper end of the bead core is 110 to 180% of a tire radial height of the bead filler from the upper end of the bead core.

3. The tire according to claim 1, wherein a nominal rim diameter of an applicable rim for the tire is larger than 57 inches, and
the electronic device is arranged at a position where its tire radial distance from an upper end of the bead core is 150 to 280% of a tire radial height of the bead filler from the upper end of the bead core.

4. The tire according to claim 1, wherein the electronic device is arranged at a position where its depth from an outer surface of the sidewall portion is 0.5 to 5.0 mm.

5. The tire according to claim 1, wherein the electronic device is arranged at a tire circumferential position that overlaps with a position of a tire serial display when viewed in the tire axial direction.

6. The tire according to claim 2, wherein the electronic device is arranged at a position where its depth from an outer surface of the sidewall portion is 0.5 to 5.0 mm.

7. The tire according to claim 3, wherein the electronic device is arranged at a position where its depth from an outer surface of the sidewall portion is 0.5 to 5.0 mm.

8. The tire according to claim 2, wherein the electronic device is arranged at a tire circumferential position that overlaps with a position of a tire serial display when viewed in the tire axial direction.

9. The tire according to claim 3, wherein the electronic device is arranged at a tire circumferential position that overlaps with a position of a tire serial display when viewed in the tire axial direction.
